(19) United States
(12) Patent Application Publication
(10) Pub. No.: US 2025/0326667 A1
(43) Pub. Date: Oct. 23, 2025

(54) COAGULANT FOR WATER TREATMENT

(71) Applicant: PENCCO, INC., Sealy, TX (US)

(72) Inventor: Roderick ABINET, Cave Creek, AZ (US)

(21) Appl. No.: 19/175,593

(22) Filed: Apr. 10, 2025

Related U.S. Application Data
(60) Provisional application No. 63/635,428, filed on Apr. 17, 2024.
(60) Provisional application No. 63/728,114, filed on Dec. 4, 2024.

(51) Int. Cl. C02F 1/52; C02F 1/66; C02F 101/36

(52) U.S. Cl. CPC C02F 1/5236; C02F 1/66; C02F 2101/36

(57) ABSTRACT

A coagulant comprising a metallic salt and an acid carrier having at least one inorganic salt, an acid, and water. The metallic salt can be ferric chloride, ferric sulfate, aluminum sulfate, polyaluminium chloride, aluminum chlorohydrate, or a combination thereof. The acid carrier may comprise a first inorganic salt and a second inorganic salt. The first inorganic salt can be ammonium sulfate, and the second inorganic salt can be ammonium bisulfate. The acid can be phosphoric acid, a hydrogen halide, nitric acid, sulfuric acid, or a combination thereof. Mixing the coagulant with raw water generates a plurality of acid pockets in the raw water, causing reactions between the blended coagulant and the dissolved organic matter.

### CROSS-REFERENCE TO RELATED APPLICATIONS

This application claims the benefit of provisional U.S. Application No. 63/635,428 entitled “Coagulant for Water Treatment” filed Apr. 17, 2024, and provisional U.S. Application No. 63/728,114 entitled “Coagulant for Water Treatment” filed Dec. 4, 2024, the technical disclosure of both of which are incorporated herein by reference in their entirety.

### BACKGROUND

### Technical Field

The present disclosure relates to coagulants used in water treatment, and particularly to blended coagulants for drinking water.

### Description of Related Art

Various water treatment systems have been implemented to produce drinking water. Typically, coagulants like Aluminum Chlorohydrate (ACH) and PolyAluminum Chlorides (PACL) have been used to remove organic materials. Conventional coagulants predominantly work by either charge neutralization or sweep flocculation, or both. However, conventional coagulants typically do a poor job of treating dissolved organic materials in water. As average environmental temperatures keep climbing, so does the increase in organic materials present in different forms. This often leads to more chlorination with various treatment strategies. This excess can react with certain organic precursors and cause harmful, regulated disinfection by products. Accordingly, a need exists for a coagulant that has dispersion properties to remove dissolved organic material from raw untreated water sources.

### BRIEF SUMMARY

This summary provides a discussion of aspects of certain embodiments of the invention. It is not intended to limit the claimed invention or any of the terms in the claims. The summary provides some aspects, but there are aspects and embodiments of the invention that are not discussed here.

In one aspect, a coagulant includes a metallic salt and an acid carrier having at least one inorganic salt, an acid, and water. The metallic salt can be ferric chloride, ferric sulfate, aluminum sulfate, polyaluminium chloride, aluminum chlorohydrate, or a combination thereof. The acid carrier may comprise a first inorganic salt and a second inorganic salt. The first inorganic salt can be ammonium sulfate, and the second inorganic salt can be polyammonium bisulfate. The acid can be phosphoric acid, a hydrogen halide, nitric acid, sulfuric acid, or a combination thereof.

The ferric sulfate can have a percent weight between 15 and 45, the acid carrier can have a percent weight between 9 and 30, and the water can have a percent weight between 35 and 75.

The acid carrier can have 1-5 molecules of ammonium sulfate, 1-20 molecules of polyammonium bisulfate, 1-5 molecules of sulfuric acid, and 0-5 molecules of water.

The pH of the coagulant can be between 0.1 and 2.

The coagulant can also include a polymer. The polymer can be a polyacrylamide.

In another aspect, a coagulant is provided. The coagulant can include a metallic salt, an acid carrier, and an ammonium sulfate. The acid carrier can include at least one inorganic salt, an acid, and water.

In one embodiment, the acid carrier can include a first inorganic salt and a second inorganic salt. The first inorganic salt can be ammonium sulfate, and the second inorganic salt can be ammonium bisulfate.

The acid can be phosphoric acid, a hydrogen halide, nitric acid, sulfuric acid, or a combination thereof.

In yet another aspect, a method for treating water containing dissolved organic matter is disclosed. The method can include blending a metallic salt with an acid carrier to produce a blended coagulant. The method can also include mixing the blended coagulant with the water. The acid carrier generates a plurality of acid pockets in the wastewater, causing reactions between the blended coagulant and the dissolved organic matter. The method can also include removing the dissolved organic matter to produce treated water. The method can also include analyzing the treated water.

The analysis can include taking a UV254 reading of the treated water. Treated water can have a UV254 reading of less than about 0.20/cm. Additionally, or alternatively, the analysis can include taking a total organic carbon (TOC) reading. Treated water can have a TOC reading of less than about 2.67 ppm in low alkaline water and less than about 2.85 ppm in high alkaline water.

Additionally, or alternatively, the analysis can include taking a turbidity reading. Treated water can have a turbidity reading of less than about 3 NTU.

The metallic salt can be at least one of ferric chloride, ferric sulfate, aluminum sulfate, polyaluminium chloride, and aluminum chlorohydrate. The acidifying formulation comprises a combination of ammonium sulfate, polyammonium bisulfate, sulfuric acid, and water.

The pH of the treated water can be between 5 and 8.

The step of mixing the blended coagulant with the raw water can also include a polymer to increase the settling of the mixture. The polymer can be a polyacrylamide.

### BRIEF DESCRIPTION OF THE DRAWINGS

The preceding aspects and many of the attendant advantages of the present technology will become more readily appreciated by reference to the following Detailed Description when taken in conjunction with the accompanying simplified drawings of example embodiments. The drawings briefly described below are presented for ease of explanation and do not limit the scope of the claimed subject matter.

FIG. 1 depicts a method for treating water.

FIGS. 2A-2D are graphs showing data obtained from treating low alkalinity water with a blended coagulant.

FIGS. 3A-3D are graphs showing data obtained from treating high alkalinity water with a blended coagulant.

FIGS. 4A-4C are graphs obtained from treating raw water with a blended coagulant.

FIG. 5 is a graph obtained from treating raw water with a blended coagulant.

### DETAILED DESCRIPTION

The present disclosure relates to high performance blends of coagulants used in water treatment, particularly for drinking water. The coagulants can be iron salts or aluminum salts that are blended with an acidifying solution (or acid carrier). The coagulant can include Ferric Chloride, Ferric Sulfate, Aluminum Sulfate, Polyaluminum Chloride, or Aluminum Chlorohydrate. The acidifying solution can be a combination of one or more inorganic salts, an acid, and water. The inorganic salt can include ammonium sulfate, ammonium bisulfate, polyammonium bisulfate, or any combination thereof. The acid can include phosphoric acid, hydrogen halide, nitric acid, sulfuric acid, or a combination thereof.

In at least one embodiment, the acid carrier can be the chelating compound as disclosed in U.S. Pat. Nos. 10,662,093, 10,093,564, 10,329,178, 10,544,055, and 10,807,889, which are incorporated by reference as if fully set forth herein. The acid carrier can have the following stoichiometric amounts: between 1-5 molecules of ammonium sulfate, 1-5 molecules of sulfuric acid, 0-5 molecules of water, and 1-20 molecules of ammonium bisulfate. Additionally, or alternatively, the acid carrier can have a mass percentage of hydrogen between 3-6 percent, a mass percentage of nitrogen between about 10-15 percent, a mass percentage of sulfur between 20-30 percent, and a mass percentage of oxygen between 52-60 percent. The acid carrier can have a pH below 2 when mixed with water. The nitrogen atoms in the acid carrier can have an oxidation state of −3, and the sulfur atoms in the acid carrier can have an oxidation state of +6. The acid carrier can be formed by adding and mixing anhydrous liquid ammonia and a first portion of an acid to flowing water to form a mixed fluid. The mixed fluid can be cooled by flowing the mixed fluid through a heat exchanger. A second portion of the acid can be added to the mixed fluid to form a product fluid comprising the acid carrier, wherein the second portion of the acid is greater than the first portion of the acid. The acid may be phosphoric acid (or a derivative of phosphoric acid), a hydrogen halide, nitric acid, and/or sulfuric acid.

In one embodiment, the blended mixture (or blended coagulant) can be formed by mixing a 60% iron sulfate solution, an acid carrier, and water. The iron (Fe) in the 60% iron sulfate solution can have a weight percentage of 10-13%. The iron sulfate (Fe2(SO4)₃) in 100 g of the 50-60% iron sulfate solution can have a weight percentage of 34-50%. An example of one embodiment of the disclosed blended coagulant is illustrated below in Table 1.

TABLE 1

| Blended Coagulant Total Volume | 5 | gal |
|---|---|---|
| Blended Coagulant Density | 8.5-10.5 | lbs/gal |
| Percent weight of iron sulfate in | 12.0-22.0% | |
| Blended Coagulant | | |
| Percent weight of iron in Blended | 2.5-7.5% | |
| Coagulant | | |
| Percent weight of acid carrier in | 6-14% | |
| Blended Coagulant | | |
| Percent weight of water in Blended | 55-70% | |
| Coagulant | | |
| Iron sulfate solution mass | 18.0-24.0 | lbs |
| Iron sulfate solution volume | 1-3.0 | gal |
| Acid carrier mass | 4-8.0 | lbs |
| Acid carrier volume | 1-3.0 | gal |
| Water from iron sulfate solution | 10-13.0 | lbs |
| Water added to Blended Coagulant | 15-24 | lbs |

In another embodiment, the disclosed blended coagulant is illustrated below in Table 2. In the embodiment depicted in Table 2, the blended coagulant does not contain any added water.

TABLE 2

| Blended Coagulant Total Volume | 0.05-0.1 | gal |
|---|---|---|
| Blended Coagulant Density | 11.5-13.5 | lbs/gal |
| Percent weight of iron sulfate in | 12.0-22.0% | |
| Blended Coagulant | | |
| Percent weight of iron in Blended | 2.5-7.5% | |
| Coagulant | | |
| Percent weight of acid carrier in | 6-14% | |
| Blended Coagulant | | |
| Percent weight of water in Blended | 55-70% | |
| Coagulant | | |
| Iron sulfate solution mass | 0.1-0.7 | lbs |
| Iron sulfate solution volume | 0.01-0.05 | gal |
| Acid carrier mass | 0.04-1.6 | lbs |
| Acid carrier volume | 0.003-0.02 | gal |
| Water from iron sulfate solution | 0.05-0.4 | lbs |

| | |
|---|---|
| Water added to Blended Coagulant | N/A |

In yet another embodiment, the disclosed blended coagulant is illustrated below in Table 3. In the embodiment depicted in Table 3, the blended coagulant contains added water.

TABLE 3

| Blended Coagulant Total Volume | 0.5-1.0 | gal |
|---|---|---|
| Blended Coagulant Density | 11.5-13.5 | lbs/gal |
| Percent weight of iron sulfate in | 12.0-22.0% | |
| Blended Coagulant | | |
| Percent weight of iron in Blended | 2.5-7.5% | |
| Coagulant | | |
| Percent weight of acid carrier in | 6-14% | |
| Blended Coagulant | | |
| Percent weight of water in Blended | 55-70% | |
| Coagulant | | |
| Iron sulfate solution mass | 2.0-6.0 | lbs |
| Iron sulfate solution volume | 0.1-0.5 | gal |
| Acid carrier mass | 1.0-2.2 | lbs |
| Acid carrier volume | 0.05-0.2 | gal |
| Water from iron sulfate solution | 2.0-3.5 | lbs |
| Water added to Blended Coagulant | 2.5-6.5 | lbs |

In yet another embodiment, the disclosed blended coagulant is illustrated below in Table 4. In the embodiment depicted in Table 4, the blended coagulant does not contain any added water.

TABLE 4

| Blended Coagulant Total Volume | 0.005-0.5 | gal |
|---|---|---|
| Blended Coagulant Density | 11.5-13.5 | lbs/gal |
| Percent weight of iron sulfate in | 16.0-25.0% | |
| Blended Coagulant | | |
| Percent weight of iron in Blended | 2.5-7.5% | |
| Coagulant | | |
| Percent weight of acid carrier in | 8.0-16.0% | |
| Blended Coagulant | | |
| Percent weight of water in Blended | 60-75% | |
| Coagulant | | |
| Iron sulfate solution mass | 0.05-0.3 | lbs |
| Iron sulfate solution volume | 0.005-0.05 | gal |
| Acid carrier mass | 0.025-0.1 | lbs |
| Acid carrier volume | 0.005-0.02 | gal |
| Water from iron sulfate solution | 0.04-0.2 | lbs |

| | |
|---|---|
| Water added to Blended Coagulant | N/A |

In yet another embodiment, the disclosed blended coagulant is illustrated below in Table 5. In the embodiment depicted in Table 5, the blended coagulant contains added water.

TABLE 5

| Blended Coagulant Total Volume | 0.01-0.1 | gal |
|---|---|---|
| Blended Coagulant Density | 8.5-11.0 | lbs/gal |
| Percent weight of iron sulfate in | 16.0-25.0% | |
| Blended Coagulant | | |
| Percent weight of iron in Blended | 2.5-7.5% | |
| Coagulant | | |
| Percent weight of acid carrier in | 8.0-16.0% | |
| Blended Coagulant | | |
| Percent weight of water in Blended | 60-75% | |
| Coagulant | | |
| Iron sulfate solution mass | 0.05-0.3 | lbs |
| Iron sulfate solution volume | 0.005-0.05 | gal |
| Acid carrier mass | 0.025-0.1 | lbs |
| Acid carrier volume | 0.001-0.01 | gal |
| Water from iron sulfate solution | 0.04-0.2 | lbs |
| Water added to Blended Coagulant | 0.05-0.25 | lbs |

In the above-described embodiments, the acid carrier can be any of the acid carriers (or chelating compounds disclosed in U.S. Pat. Nos. 10,662,093, 10,093,564, 10,329,178, 10,544,055, and 10,807,889. Alternatively, the acid carrier can be ammonium sulfate.

The coagulant portion provides the blended mixture with charge neutralization and sweep flocculation properties that allow the blended mixture to treat particulate organic matter. However, when the blended coagulant is mixed with raw water for treatment, the acidifying solution acts like a dispersant based on its structure, creating pockets of localized acidity. The acid pockets advantageously create more reactions with organics than conventional coagulants. In particular, the acid pockets create reactions with smaller dissolved fractionations, including dissolved organic matter (DOM) fractions in the water. Additionally, two heavily regulated contaminants of major concern are Haloacetic Acids (HAA5s) and Total Trihalomethanes (TTHMs) may be removed or diminished by the blended coagulant.

Contaminant removal can be measured by determining the total organic carbon levels in a sample. Another measurement of determining contaminant removal is measuring the UV254 or specific ultraviolet absorbance (SUVA) levels of the sample. Another measurement that captures the effectiveness of the disclosed blended coagulant's contaminant removal is measuring the protein-like fluorescence components for fluorescent dissolved organic matter. Unlike other conventional tests, the fluorescent dissolved organic matter method captures other disinfection by products (DPBs) that are not measured with total organic carbon (TOC) readings (e.g., HAA5 and TTHM). An example of the fluorescent dissolved organic matter method is described in David W. Johnstone & Christopher M. Miller. “Fluorescence Excitation-Emission Matrix Regional Transformation and Chlorine Consumption to Predict Trihalomethane and Haloacetic Acid Formation.” Environmental Engineering Science, vol. 26, no. 7, 2009, pp. 1163-1170, which is incorporated by reference as if fully set forth herein.

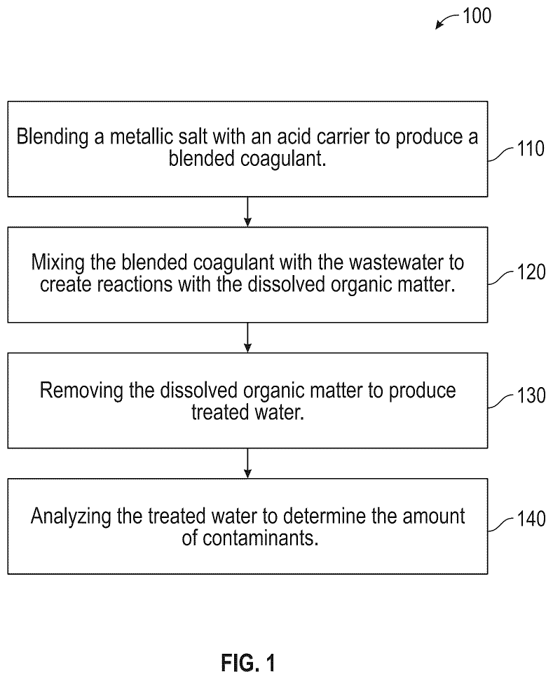

The blended coagulant may be used to treat raw untreated water sources. In particular, the blended coagulant may be used to treat water containing dissolved organic matter. With reference to FIG. 1, a method 100 of treating raw water containing dissolved organic matter starts at step 110 with blending a metallic salt with an acid carrier to produce a blended coagulant. At step 120 by mixing the blended coagulant with the untreated water. As the blended coagulant mixes with the water, the acid carrier generates acid pockets in the water that cause the blended coagulant to react with the dissolved organic matter. The method continues at step 130 by removing the dissolved organic matter to produce treated water. Once the reactions between the blended coagulant and the dissolved organic matter complete, the dissolved organic matter flocculates/precipitates and may be removed via filtration, reverse osmosis, ion exchange, or a combination thereof.

At step 140, the treated water is analyzed to determine the amount of contaminants. The analysis can include taking a UV254 reading of the treated water. Treated water has a UV254 reading of less than about 0.20/cm. Additionally, or alternatively, the analysis can include taking a total organic carbon (TOC) reading. Treated water has a TOC reading of less than about 3 ppm. Additionally, or alternatively, the analysis can include taking a turbidity reading. Treated water has a turbidity reading of less than about 3 NTU.

### TESTING EXAMPLES

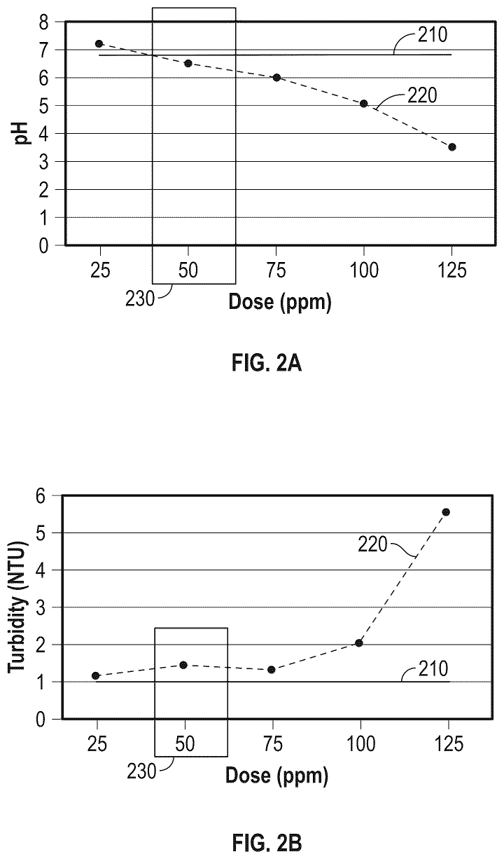

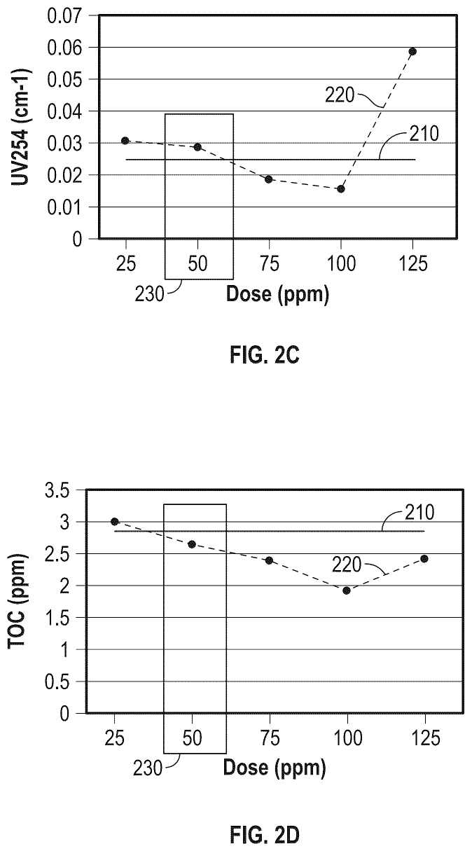

Example 1—High Alkalinity Evaluation. In this example, a jar having a volume of 1 L with 100 mg/L CaCO₃ was tested with the blended coagulant disclosed in Table 1 at doses of 25 ppm, 50 ppm, 75 ppm, 100 ppm, and 125 ppm. A ferric sulfate coagulant was used as a control at a dose of 100 ppm (Jar 1). The results of the ferric sulfate coagulant 210 and the various doses of the blended coagulant 220 are reproduced below in Table 6 and illustrated in FIGS. 2A-2D. The blended coagulant having half the dose of ferric sulfate coagulant is identified as 230.

TABLE 6

| | Raw Water | Jar 1 | Jar 2 | Jar 3 | Jar 4 | Jar 5 | Jar 6 |
|---|---|---|---|---|---|---|---|
| Dose | — | 100 | 25 | 50 | 75 | 100 | 125 |
| (ppm) | | | | | | | |
| Coagulant | — | 190.2 | 104.6 | 209.2 | 313.8 | 418.4 | 523 |
| Volume | | | | | | | |
| (μL) | | | | | | | |
| pH | 7.73 | 6.84 | 7.21 | 6.53 | 6.03 | 5.07 | 3.54 |
| Turbidity | 9.39 | 0.95 | 1.15 | 1.45 | 1.31 | 2.02 | 5.55 |
| (NTU) | | | | | | | |
| UV254 | 0.064 | 0.025 | 0.031 | 0.029 | 0.019 | 0.016 | 0.059 |
| (1/cm) | | | | | | | |
| TOC | 4.06 | 2.85 | 3.01 | 2.65 | 2.39 | 1.93 | 2.41 |
| (ppm) | | | | | | | |
| Total Iron | 0.65 | 1.04 | 0.98 | 1.63 | 1.80 | 2.33 | 4.85 |
| (ppm) | | | | | | | |

As seen in FIG. 2A, the pH of the blended coagulant and water mixture decreased as the dosage of the blended coagulant increased. However, it is notable that the pH of the half dose 230 of the blended coagulant was slightly lower than the pH of the ferric sulfate coagulant control dose.

Referring to FIG. 2B, although the turbidity of the blended coagulant increased with the larger doses, the turbidity of the half dose 230 of the blended coagulant was only slightly higher than the turbidity of the ferric sulfate coagulant control dose.

In FIG. 2C, the UV254 readings (i.e., contaminant readings) decreased with increasing dosage, with the half dose 230 of the blended coagulant producing a comparable reading to the ferric sulfate coagulant control dose.

In FIG. 2D, the TOC readings (i.e., contaminant readings) decreased with increasing dosage, with the half dose 230 of the blended coagulant producing a superior reading to the ferric sulfate coagulant control dose.

Accordingly, the blended coagulant, at a half dose, produced comparable or superior contaminant reducing properties to conventional coagulants without noticeably altering the pH or turbidity levels.

Example 2—Low Alkalinity Evaluation. In this example, a jar having a volume 1 L with 55 mg/L CaCO₃ was tested with the blended coagulant disclosed in Table 1 at doses of 10 ppm, 15 ppm, 25 ppm, 35 ppm, and 45 ppm. A ferric sulfate coagulant was used as a control at a dose of 50 ppm (Jar 1). The results of the test are reproduced below in Table 7. As seen in Table 7, the turbidity of the raw water was unable to be measured.

TABLE 7

| | Raw Water | Jar 1 | Jar 2 | Jar 3 | Jar 4 | Jar 5 | Jar 6 |
|---|---|---|---|---|---|---|---|
| Dose | — | 50 | 10 | 15 | 25 | 35 | 45 |
| (ppm) | | | | | | | |
| Coagulant | — | 95.1 | 41.8 | 62.78 | 104.6 | 146.4 | 188.3 |
| Volume | | | | | | | |
| (μL) | | | | | | | |
| pH | 7.60 | 6.57 | 6.79 | 6.77 | 6.34 | 6.11 | 5.06 |
| Turbidity | — | 2.74 | 6.86 | 2.55 | 2.95 | 2.90 | 2.92 |
| (NTU) | | | | | | | |
| UV254 | 0.077 | 0.025 | 0.034 | 0.028 | 0.021 | 0.018 | 0.020 |
| (1/cm) | | | | | | | |
| TOC | 3.6 | 2.67 | 2.8 | 2.92 | 2.48 | 1.96 | 2.09 |
| (ppm) | | | | | | | |
| Total Iron | 2.25 | 0.66 | 1.63 | 0.73 | 0.69 | 0.86 | 1.01 |
| (ppm) | | | | | | | |

During this test, influent turbidity was unusually high due to recent rain. Accordingly, the settled turbidity was close to 3 NTU, including in the control of Jar 1.

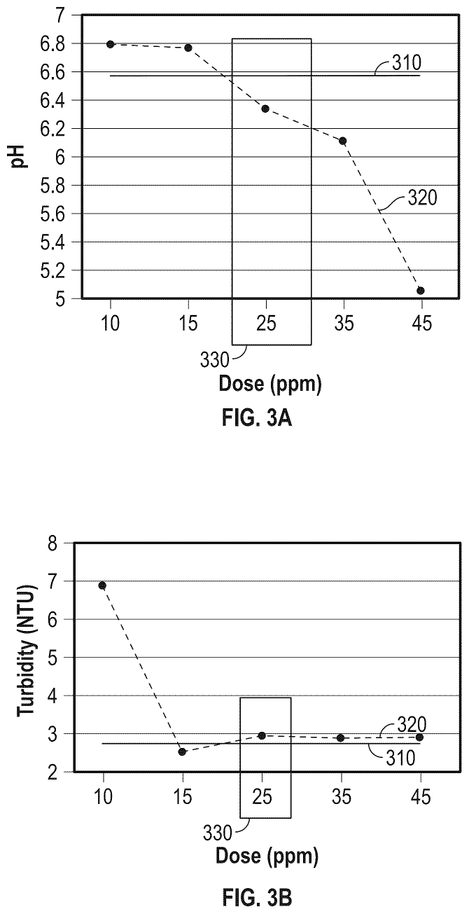

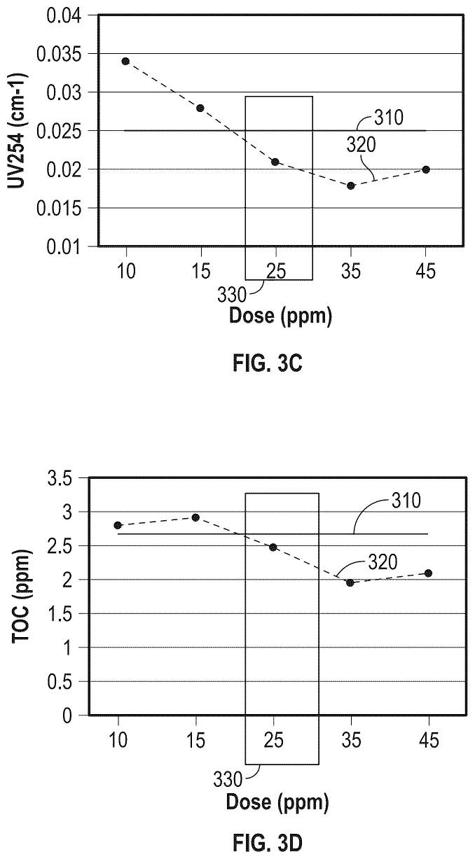

As seen in FIG. 3A, the pH of the blended coagulant and water mixture decreased as the dosage of the blended coagulant increased. However, it is notable that the pH of the half dose 230 of the blended coagulant was only slightly lower than the pH of the ferric sulfate coagulant control dose.

Referring to FIG. 3B, the turbidity of the blended coagulant was relatively stable across the doses and only slightly higher than the ferric sulfate coagulant control dose.

In FIG. 3C, the UV254 readings (i.e., contaminant readings) decreased with increasing dosage, with the half dose 230 of the blended coagulant producing a superior reading to the ferric sulfate coagulant control dose.

In FIG. 3D, the TOC readings (i.e., contaminant readings) decreased with increasing dosage, with the half dose 230 of the blended coagulant producing a superior reading to the ferric sulfate coagulant control dose.

Accordingly, the blended coagulant, at a half dose, produced comparable or superior contaminant reducing properties to conventional coagulants without noticeably altering the pH or turbidity levels.

Example 3—Comparative Fluorescent Dissolved Organic Matter Analysis. In this example, three different coagulant formulations were tested to analyze the effectiveness of removing organic materials. The fluorescent dissolved organic matter method uses parallel factor analysis (PARAFAC) to identify the protein-like fluorescence components. In one example, PARAFAC identifies a tyrosine-like protein (F-C1) and a tryptophan-like protein (F-C2), whose fluorescence intensities are directly correlated to DOM levels. In one embodiment, the method for determining the fluorescent dissolved organic matter levels can include measuring the colored dissolved organic matter between 200-800 nm at 1 nm intervals using a spectrometer. The absorption coefficient (α) was calculated using the following equation, where l is the path length of the optical cell in meters, and A(λ) is the absorbance at a certain wavelength.

$$α = 2.3 \; 03 A ( λ ) / l$$

The fluorescence excitation-emission measurements (EEM) of the samples can be measured with a fluorescence spectrometer. The samples can be measured at excitation wavelengths ranging from 200-450 nm (at 5 nm increments) and emission wavelengths ranging from 250-600 nm (at 5 nm increments). In the illustrative example, F-C1 had excitation wavelengths at about 276 nm and a maximum emission wavelength of about 316 nm. F-C2 had excitation wavelengths at about 232 nm and a maximum emission wavelength of about 348 nm. The EEM measurements can be converted to Raman units (RU) by normalizing the EEM measurements to the area under the Raman peak at a 350 nm excitation wavelength.

The concentrations of the various components of the tested coagulants are listed below in Table 8. Samples 1 and 2 include Aluminum Sulfate 410, Sodium Permanganate 420, Chlorine Dioxide 430, and Polyaluminum Chloride 440. Sample 3 includes Aluminum Sulfate 410, Sodium Permanganate 420, and a blended coagulant 450 as described in Table 1.

TABLE 8

| | | Sodium | | Polyalu- | |
|---|---|---|---|---|---|
| | Aluminum | Perman- | Chlorine | minum | Blended |
| | Sulfate | ganate | Dioxide | Chloride | Coagulant |
| Sample 1 | 55 mg/L | 0.8 mg/L | 0.6 mg/L | 10 mg/L | — |
| Sample 2 | 55 mg/L | 0.8 mg/L | 0.6 mg/L | 5 mg/L | — |
| Sample 3 | 55 mg/L | 0.8 mg/L | — | — | 1.7 ppm |

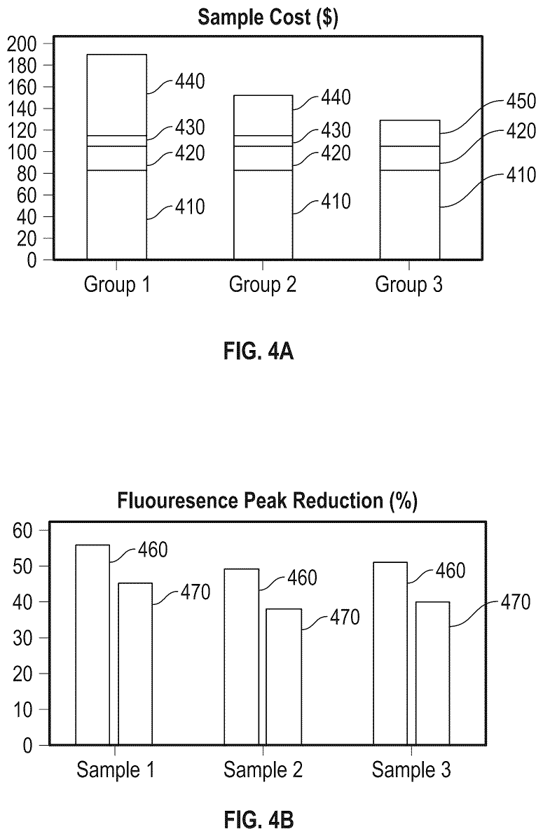

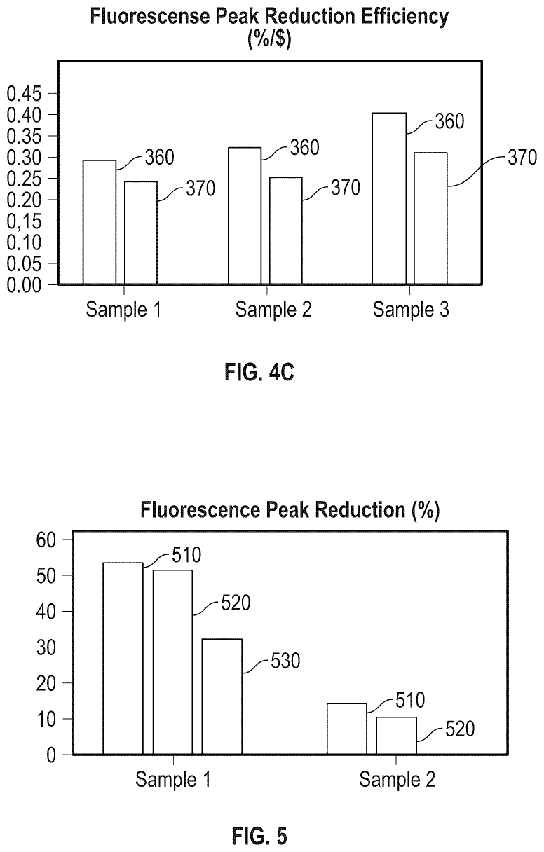

The cost of the components in each sample is listed below in Table 9 and reproduced as a bar graph in FIG. 4A. As can be seen, the overall cost of Sample 3 is lower than the cost of the other samples.

TABLE 9

| | | Sodium | | Polyalu- | |
|---|---|---|---|---|---|
| | Aluminum | Perman- | Chlorine | minum | Blended |
| | Sulfate | ganate | Dioxide | Chloride | Coagulant |
| Sample 1 | $82.88 | $22.5 | $9.2 | $75.83 | — |
| Sample 2 | $82.88 | $22.5 | $9.2 | $37.92 | — |
| Sample 3 | $82.88 | $22.5 | — | — | $24.05 |

After using each sample to treat the raw water, the treated samples were analyzed by monitoring the fluorescent readings to determine the amount of F-C1 and F-C2 removal. The percent removal of the F-C1 and F-C2 were calculated by dividing the normalized EEM measurements of the samples by the normalized EEM measurements of the raw water. The results for each sample are listed below in Table 10 and reproduced as a bar graph in FIG. 4B. As can be seen, Sample 3 produces comparable results in removing F-C1 (360) and F-C2 (370) as the other samples.

TABLE 10

| | F-C1 Removal | F-C2 Removal |
|---|---|---|
| Sample 1 | 56% | 45% |
| Sample 2 | 49% | 38% |
| Sample 3 | 51% | 40% |

The fluorescence peak reduction efficiency (i.e., percent removal/cost) is listed below in Table 11 and reproduced as a bar graph in FIG. 4C. Notably, Sample 3 is more efficient in removing F-C1 (360) and F-C2 (370) components.

TABLE 11

| | F-C1 Removal | F-C2 Removal |
|---|---|---|
| Sample 1 | 0.29 | 0.24 |
| Sample 2 | 0.32 | 0.25 |
| Sample 3 | 0.40 | 0.31 |

Example 4-Comparative Fluorescent Dissolved Organic Matter Analysis. In this example, a 12 mg/L concentration of the blended coagulant, as disclosed in Table 1, was compared to a 12 mg/L concentration of an iron sulfate coagulant to determine the reduction of contaminants in raw water. Like Example 3, Example 4 followed the same fluorescent dissolved organic matter method.

The removal results are listed below in Table 12 and reproduced as a bar graph in FIG. 5. As can be seen, the disclosed coagulant blend produces superior contaminant reduction compared to a conventional iron sulfate coagulant. In particular, the blended coagulant produced superior removal results concerning F-C1 (510), F-C2 (520), and UV254 (530). Accordingly, not only will the disclosed blended coagulant produce superior results compared to conventional iron sulfate coagulants at the same concentration, but so too will the blended coagulant at lower concentrations.

TABLE 12

| | F-C1 Removal | F-C2 Removal | UV254 Removal |
|---|---|---|---|
| Sample 1 | 53% | 51% | 32% |
| Sample 2 | 14% | 10% | — |

Example 5—Comparative Chlorine Residual Analysis. In this example, a ferric sulfate coagulant (e.g., Jar 1 in Table 6) was compared to a blended coagulant (e.g., Table 3 using liquid ammonium sulfate as the acid carrier) to assess the stability of chlorine. The example was performed over a 36-day period. As seen in Table 13, the properties of the blended coagulant compared to the ferric sulfate coagulant show an increase in the amount of chlorine residual in the sample at the beginning of the testing (Clᵢ) and the end of the testing (Cl_{f}). Consequently, the disclosed blended coagulants using ammonium sulfate as the acid carrier advantageously increase the stability of chlorine in the sample compared to other coagulants. In particular, the disclosed blended coagulants can stabilize chlorine by transforming it into a chloramine form. Thus, the added presence of chlorine in the sample provides superior disinfecting properties.

TABLE 13

| | Regular Ferric Coagulant | Blended Coa1gulant |
|---|---|---|
| pH | 6.62 | 6.39 |
| Alkalinity (ppm) | 64.00 | — |
| Turbidity (NTU) | 0.40 | 0.69 |
| UV254 (1/cm) | 0.019 | 0.018 |
| Cl Dose (mg/l) | 3.0 | 4.6 |
| Cl Residual (mg/l) | 2.46 | 2.50 |
| Lime Dose (mg/l) | 8 | 10 |
| pH_{f} | 7.97 | 8.30 |
| Tᵢ (° F.) | 25.6 | 25.6 |
| pHᵢ | 7.65 | 8.18 |
| Clᵢ (mg/l) | 1.73 | 1.88 |
| T_{f} (° F.) | 25.6 | 25.6 |
| pH_{f} | 7.65 | 7.96 |
| Cl_{f} (mg/l) | 0.81 | 1.08 |

Example 6—Comparative Jar Testing Analysis. In this example, a jar testing procedure for treating water was performed. The procedure includes four sets of tests performed to assess the effectiveness of the disclosed blended coagulant compared to conventional ferric sulfate. In the first set of testing (see Table 14), six jar samples were taken that were filtered and had no polymer to aid in the settling of the mixture. Jar 1 did not contain any coagulant, Jar 2 contained the conventional ferric sulfate coagulant, Jar 3 contained the conventional ferric sulfate coagulant, Jar 4 contained the disclosed blended coagulant, Jar 5 contained a diluted form of the disclosed blended coagulant, and Jar 6 contained a diluted form of the disclosed blended coagulant.

TABLE 14

| | Jar 1 | Jar 2 | Jar 3 | Jar 4 | Jar 5 | Jar 6 |
|---|---|---|---|---|---|---|
| Coagulant | — | Ferric | Ferric | Blended | Blended | Blended |
| (ppm) | | Sulfate (55.2) | Sulfate (55.2) | Coagulant (55.2) | Coagulant (27.6) | Coagulant (27.6) |
| Lime | 49 | 49 | 49 | 49 | 49 | 49 |
| (ppm) | | | | | | |
| Polymer | — | — | — | — | — | — |
| (ppm) | | | | | | |
| pH | 8.2 | 7.4 | 7.4 | 7.4 | 7.8 | 7.8 |
| Turbidity | 0.15 | 0.16 | 0.15 | 0.05 | 0.09 | 0.045 |
| (NTU) | | | | | | |
| Alkalinity | 105 | 81 | 84 | 82 | 96 | 98 |
| (ppm) | | | | | | |
| TOC (ppm) | 4.83 | 4.20 | 3.96 | 3.89 | 4.41 | 4.38 |
| UV254 | 0.071 | 0.055 | 0.053 | 0.054 | 0.062 | 0.061 |
| (1/cm) | | | | | | |
| SUVA | 1.47 | 1.31 | 1.34 | 1.39 | 1.41 | 1.39 |
| (L/mg-m) | | | | | | |

In the second set of testing (see Table 15), six jar samples were taken that were unfiltered and had no polymer to aid in the settling of the mixture. Jar 1 did not contain any coagulant, Jar 2 contained the conventional ferric sulfate coagulant, Jar 3 contained the conventional ferric sulfate coagulant, Jar 4 contained the disclosed blended coagulant, Jar 5 contained a slightly less diluted form of the disclosed blended coagulant, and Jar 6 contained a diluted form of the disclosed blended coagulant.

TABLE 15

| | Jar 1 | Jar 2 | Jar 3 | Jar 4 | Jar 5 | Jar 6 |
|---|---|---|---|---|---|---|
| Coagulant | — | Ferric | Ferric | Blended | Blended | Blended |
| | | Sulfate (55.2) | Sulfate (55.2) | Coagulant (55.2) | Coagulant (27.6) | Coagulant (27.6) |
| Lime | 49 | 49 | 49 | 49 | 49 | 49 |
| Polymer | — | — | — | — | — | — |
| (ppm) | | | | | | |
| pH | 8.2 | 7.2 | 7.2 | 7.2 | 7.4 | 7.7 |
| Turbidity | 8.7 | 1.05 | 0.76 | 0.42 | 0.77 | 0.68 |
| (NTU) | | | | | | |
| Alkalinity | 107 | 85 | 86 | 83 | 96 | 98 |
| (ppm) | | | | | | |
| TOC (ppm) | 5.19 | 4.90 | 4.10 | 3.97 | 4.37 | 4.58 |
| UV254 | 0.12 | 0.079 | 0.071 | 0.070 | 0.082 | 0.092 |
| (1/cm) | | | | | | |
| SUVA | 2.31 | 1.61 | 1.73 | 1.76 | 1.88 | 2.01 |
| (L/mg-m) | | | | | | |

In the third set of testing (see Table 16), six jar samples were taken that were filtered and contained a polymer (e.g., a polyacrylamide) to aid in the settling of the mixture. Jar 1 did not contain any coagulant, Jar 2 contained the conventional ferric sulfate coagulant, Jar 3 contained the conventional ferric sulfate coagulant, Jar 4 contained the disclosed blended coagulant, Jar 5 contained a diluted form of the disclosed blended coagulant, and Jar 6 contained a diluted form of the disclosed blended coagulant

TABLE 16

| | Jar 1 | Jar 2 | Jar 3 | Jar 4 | Jar 5 | Jar 6 |
|---|---|---|---|---|---|---|
| Coagulant | — | Ferric | Ferric | Blended | Blended | Blended |
| | | Sulfate (55.2) | Sulfate (55.2) | Coagulant (55.2) | Coagulant (41.4) | Coagulant (27.6) |
| Lime | 49 | 49 | 49 | 49 | 49 | 49 |
| Polymer | — | — | — | — | — | — |
| (ppm) | | | | | | |
| pH | 8.3 | 7.3 | 7.3 | 7.5 | 7.5 | 7.6 |
| Turbidity | 0.153 | 0.046 | 0.055 | 0.051 | 0.058 | 0.048 |
| (NTU) | | | | | | |
| Alkalinity | 111 | 87 | 84 | 98 | 93 | 94 |
| (ppm) | | | | | | |
| TOC (ppm) | 4.69 | 3.98 | 3.83 | 4.03 | 4.10 | 4.21 |
| UV254 | 0.071 | 0.056 | 0.054 | 0.057 | 0.058 | 0.061 |
| (1/cm) | | | | | | |
| SUVA | 1.51 | 1.41 | 1.41 | 1.41 | 1.41 | 1.45 |
| (L/mg-m) | | | | | | |

In the fourth set of testing (see Table 17), six jar samples were taken that were unfiltered and contained a polymer (e.g., a polyacrylamide) to aid in the settling of the mixture. Jar 1 did not contain any coagulant, Jar 2 contained the conventional ferric sulfate coagulant, Jar 3 contained the conventional ferric sulfate coagulant, Jar 4 contained the disclosed blended coagulant, Jar 5 contained a slightly less diluted form of the disclosed blended coagulant, and Jar 6 contained a diluted form of the disclosed blended coagulant.

TABLE 17

| | Jar 1 | Jar 2 | Jar 3 | Jar 4 | Jar 5 | Jar 6 |
|---|---|---|---|---|---|---|
| Coagulant | — | Ferric | Ferric | Blended | Blended | Blended |
| | | Sulfate (55.2) | Sulfate (55.2) | Coagulant (55.2) | Coagulant (41.4) | Coagulant (27.6) |
| Lime | 49 | 49 | 49 | 49 | 49 | 49 |
| Polymer | 1.0 | 1.0 | 1.0 | 1.0 | 1.0 | 1.0 |
| (ppm) | | | | | | |
| pH | 8.1 | 7.3 | 7.2 | 7.2 | 7.3 | 7.4 |
| Turbidity | 7.1 | 0.48 | 0.43 | 0.47 | 0.49 | 0.046 |
| (NTU) | | | | | | |
| Alkalinity | 102 | 82 | 89 | 85 | 92 | 92 |
| (ppm) | | | | | | |
| TOC (ppm) | 4.97 | 4.71 | 3.86 | 4.12 | 4.16 | 4.35 |
| UV254 | 0.118 | 0.074 | 0.073 | 0.078 | 0.084 | 0.090 |
| (1/cm) | | | | | | |
| SUVA | 2.37 | 1.57 | 1.89 | 1.89 | 2.02 | 2.07 |
| (L/mg-m) | | | | | | |

As seen in the above testing results, the blended coagulant (at all dosage levels) performed nearly as well as the conventional ferric sulfate coagulants but displayed better performance after filtration. Furthermore, the disclosed coagulant at diluted levels (e.g., 50% of normal dosage) regularly met the SUVA requirements (e.g., below 2.0 (L/mg-m)). Moreover, the disclosed blended coagulant advantageously maintained pH levels that are equal to or greater than the levels of the conventional ferric sulfate coagulants, which provides a cost savings of having to regulate the pH levels of the treated water. The disclosed blended coagulant also advantageously does not consume nearly as much alkalinity in the water, which also provides cost savings. Therefore, the disclosed blended coagulant provides optimal water treatment properties while also providing superior pH and alkalinity-preserving properties compared to conventional coagulants.

Moreover, for the purposes of the present disclosure, the term “a” or “an” entity refers to one or more of that entity. As such, the terms “a” or “an,” “one or more,” and “at least one” can be used interchangeably herein.

All numeric values herein are assumed to be modified by the term “about,” whether or not explicitly indicated. For the purposes of the present invention, ranges may be expressed as from “about” one particular value to “about” another particular value. It will be understood that the endpoints of each of the ranges are significant both in relation to the other endpoint and independently of the other endpoint. When a value is expressed as an approximation by use of the antecedent “about,” it will be understood that the particular value forms another embodiment.

Additionally, the section headings herein are provided for consistency with the suggestions under 37 C.F.R. § 1.77 or to provide organizational cues. These headings shall not limit or characterize the invention(s) set out in any claims that may issue from this disclosure. Specifically, and by way of example, although the headings refer to a “Technical Field,” the claims should not be limited by the language chosen under this heading to describe the so-called field. Further, a description of a technology as background information is not to be construed as an admission that a particular technology is prior art to any embodiment(s) in this disclosure. Neither is the “Summary” a characterization of the embodiment(s) outlined in issued claims.

Furthermore, any reference in this disclosure to “invention” in the singular should not be used to argue that there is only a single point of novelty in this disclosure. Multiple embodiments may be set forth according to the limitations of the multiple claims issuing from this disclosure. Such claims accordingly define the embodiment(s) and their equivalents that are protected thereby. In all instances, the scope of such claims shall be considered on their own merits in light of this disclosure but should not be constrained by the headings set forth herein.

Moreover, the Abstract is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the preceding Detailed Description, it can be seen that various features may be grouped in a single embodiment to streamline the disclosure. This method of disclosure is not to be interpreted as reflecting an intention that the claimed embodiments require more features than are expressly recited in each claim. Instead, as the claims reflect, the inventive subject matter lies in less than all features of a single disclosed embodiment. Thus, the following claims are incorporated into the Detailed Description, with each claim standing on its own as a separate embodiment.

What is claimed is:

1. A coagulant comprising:
a metallic salt; and
an acid carrier comprising a least one inorganic salt, an acid, water, or any combination thereof.

2. The coagulant of claim 1, wherein the acid carrier comprises a first inorganic salt and a second inorganic salt.

3. The coagulant of claim 2, wherein the first inorganic salt is ammonium sulfate, the second inorganic salt is ammonium bisulfate.

4. The coagulant of claim 3, wherein the acid is phosphoric acid, a hydrogen halide, nitric acid, sulfuric acid, or a combination thereof.

5. The coagulant of claim 4, wherein the acid carrier comprises 1-5 molecules of ammonium sulfate, 1-20 molecules of ammonium bisulfate, 1-5 molecules of sulfuric acid, and 0-5 molecules of water.

6. The coagulant of claim 1, wherein the metallic salt is ferric chloride, ferric sulfate, or a combination thereof.

7. The coagulant of claim 1, wherein the metallic salt is aluminum sulfate, polyaluminium chloride, aluminum chlorohydrate, or a combination thereof.

8. The coagulant of claim 6, wherein the ferric sulfate has a percent weight between 15 and 45.

9. The coagulant of claim 1, wherein the coagulant has a pH between 0.1 and 2.

10. The coagulant of claim 6, wherein the ferric sulfate has a percent weight between 15 and 45, the acid carrier has a percent weight between 9 and 30, and the water has a percent weight between 35 and 75.

11. A coagulant comprising:
a metallic salt;
an acid carrier comprising a least one inorganic salt, an acid, water, or any combination thereof; and
an ammonium sulfate.

12. The coagulant of claim 11, wherein the acid carrier comprises a first inorganic salt and a second inorganic salt.

13. The coagulant of claim 12, wherein the first inorganic salt is ammonium sulfate, and the second inorganic salt is ammonium bisulfate.

14. The coagulant of claim 13, wherein the acid is phosphoric acid, a hydrogen halide, nitric acid, sulfuric acid, or a combination thereof.

15. A method for treating raw water containing dissolved organic matter, the method comprising:
blending a metallic salt with an acid carrier to produce a blended coagulant; and
mixing the blended coagulant with the raw water, wherein the acid carrier generates a plurality of acid pockets in the raw water, thereby generating reactions between the blended coagulant and the dissolved organic matter; and
removing the dissolved organic matter to produce treated water.

16. The method of claim 15, wherein the metallic salt comprises at least one of ferric chloride, ferric sulfate, aluminum sulfate, polyaluminium chloride, and aluminum chlorohydrate.

17. The method of claim 16, wherein:
the acidifying formulation comprises a combination of ammonium sulfate, ammonium bisulfate, sulfuric acid, and water; and
the metallic salt is ferric sulfate, and further wherein the acidifying formulation comprises 1-5 molecules of ammonium sulfate, 1-20 molecules of ammonium bisulfate, 1-5 molecules of sulfuric acid, and 0-5 molecules of water.

18. The method of claim 16, wherein:
the ferric sulfate has a percent weight between 15 and 45 in the blended coagulant; or
the treated water has a pH between 5 and 8.

19. The method of claim 15, wherein the raw water has a low alkalinity, further wherein the treated water has a UV254 reading of less than 0.20/cm, a total organic carbon reading of less than 2.67 ppm, or a combination thereof.

20. The method of claim 15, wherein the raw water has a high alkalinity, further wherein the treated water has a UV254 reading of less than 0.20/cm, a total organic carbon reading of less than 2.85 ppm, or a combination thereof.
